(19) United States
(12) Patent Application Publication
(10) Pub. No.: US 2016/0372760 A1
(43) Pub. Date: Dec. 22, 2016

(54) Battery

(71) Applicant: Leading Step Limited, Tai Kok Tsui (HK)

(72) Inventor: Kung Jui Lee, Kowloon (HK)

(73) Assignee: Leading Step Limited

(21) Appl. No.: 15/139,448

(22) Filed: Apr. 27, 2016

(30) Foreign Application Priority Data
Apr. 27, 2015 (HK) 15104051.1

(51) Int. Cl. H01M 6/32; H01M 2/36; H01M 6/02

(52) U.S. Cl. CPC H01M 6/32; H01M 6/02; H01M 2/367

(57) ABSTRACT

A body has a liquid-activatable powder mixture disposed in a metal casing with a first end that extends towards a second end longitudinally and includes at least one perforation, a conductive rod with a first end located adjacent and beyond the first end of the metal casing and extends towards the second end in contact with the powder mixture, a permeable separator, disposed between the liquid-activatable powder mixture and the metal casing, for electrically isolating the negative electrode from the positive electrode while being permeable to liquid useful in activating the powder mixture, and a passage, extending from the perforation of the metal casing through the permeable separator, for allowing a flow of liquid to activate the liquid activatable powder mixture. The metal casing is moveable relative to at least the body between a first position to expose and a second position to conceal the perforation on the metal casing.

### BACKGROUND OF THE INVENTION

The present invention relates to a battery that is particularly but not exclusively of re-useable battery activated by addition of a liquid.

Conventional batteries activated by a liquid would address the problem of long term storage resulting in inactivation and deterioration. The activation of such batteries requires addition of liquid usually by way of soaking the battery in a bath of liquid. The liquid molecules in the liquid spontaneously move through a partially permeable membrane into the interior of the battery by osmosis. The rate of movement of the liquid molecules tends to be slow. This is particularly undesirable when an emergency situation arises requiring urgent functioning of the battery.

Conventionally, a cap is usually provided to cover the opening through which liquid enters the battery. The cap is easily lost or constitutes a small part swallow-able by young children rendering its use unfit for toy designed to the entertainment of children at a certain age.

Liquid is usually injected through a small aperture beneath the cap at one end of the battery. Tools may be used to put pressure on the liquid for speeding up movement across the permeable membrane. However, these are less desirable given their limitations. The tightly packed ingredients add to the problem.

Also it is not possible for users to control the amount of ingredients to be activated.

The invention seeks to mitigate or at least alleviate such shortcomings by providing a new or improved battery.

### SUMMARY OF THE INVENTION

According to the invention, there is provided a battery comprising a body having opposite first and second ends; a liquid-activatable powder mixture disposed in the body; a negative electrode, at which anions are oxidized, comprising a metal casing which has a first end extends towards a second end longitudinally and includes at least one perforation; a positive electrode, to which cations migrate, comprising a conductive rod which has a first end located adjacent and beyond the first end of the metal casing and extends towards the second end of the body in contact with the powder mixture; a permeable separator, disposed between the liquid-activatable powder mixture and the metal casing, for lining the perforation and electrically isolating the negative electrode from the positive electrode while being permeable to liquid useful in activating the powder mixture; and a passage, extending from the perforation of the metal casing through the permeable separator, for allowing a flow of liquid to activate the liquid activatable powder mixture, wherein the metal casing is moveable relative to at least the body between a first position to expose and a second position to conceal the perforation on the metal casing.

Preferably, the first end of the body and the first end of the metal casing are sealed by a first end cap.

More preferably, the body and the metal casing are separated by a further casing positioned therebetween and with first and second ends.

Yet more preferably, the further casing includes an opening which extends between the first and second ends and is aligned with the perforation on the metal casing, the further casing and the metal casing is moveable relative to the body between the first position to expose and the second position to conceal the opening on the further casing and the perforation on the metal casing.

It is preferable that the first end cap is provided with the first end of the further casing.

Advantageously, the first end cap of the further casing is integrally formed with the first end of the further casing.

More advantageously, the metal casing is movable between the first and second positions by sliding along an axis extending longitudinally through the first and second ends of the body.

Yet more advantageously, the further casing and the metal casing are arranged to have their relative position fixed by an inter-engagement means such that the further casing and the metal casing are slidable between the first and second positions in unison.

It is advantageous that the first end of the further casing is releasably coupled by a coupler to the first end of the body when the further casing is at the second position.

Preferably, the coupler includes a pair of complementary threaded engagements on the respect first ends of the body and the further casing.

More preferably, the coupler when engaged forms a waterproof coupling.

Preferably, the coupler further includes a sealed ring positioned adjacent the threaded engagement on the further casing.

More preferably, the second end of the metal casing is retained at least partially within the body by a retainer when the metal casing is moved to the second position.

Advantageously, the retainer comprises a releasable complementary threaded coupler at the second end of the metal casing and the first end of the body.

More advantageously, the second end of the further casing is retained at least partially within the body by a retainer when the further casing is moved to the second position.

Preferably, the retainer comprises a releasable complementary threaded coupler at the second end of the further casing and the first end of the body.

More preferably, the inter-engagement means includes a pair of projections on the second end of the metal casing insertable into a pair of seats on the second end of the further casing.

It is preferable that the pair of seats comprises a pair of indentations on the second end of the further casing.

Advantageously, the projection is of a shape corresponding to that of the indentation such that they form a close-fit.

More advantageously, the number of opening on the further casing correspond to the number of perforation on the metal casing.

Preferably, the metal casing comprises at least two perforations, the permeable separator that lines the perforations comprises a visual indicator at each position of the perforations for indicating passing of liquid there through.

More preferably, the threaded coupler when coupled maintains the metal casing at the second position.

More advantageously, the threaded coupler when coupled maintains the further casing at the second position.

Preferably, the threaded coupler includes a stopper to prevent rotation of the metal casing relative to the body.

Preferably, the threaded coupler includes a stopper to prevent rotation of the further casing relative to the body.

### BRIEF DESCRIPTION OF DRAWINGS

The invention will now be more particularly described, by way of example only, with reference to the accompanying drawings, in which:

FIGS. 1A, 1B and 1C show a first embodiment of a battery in accordance with the invention and usage thereof;

FIG. 2A is a front view of the battery in FIGS. 1A to 1C;

FIGS. 2B and 2C are side views of the battery in FIG. 2A;

FIG. 2D is a cross-sectional view of the battery in FIG. 2A taken along its length;

FIG. 3A is a front view of a body of the battery in FIGS. 1A to 1C;

FIGS. 3B and 3C are side views of the body in FIG. 3A;

FIG. 3D is a cross-sectional view of the battery in FIG. 3A taken along its length;

FIG. 3E is an enlarged view of a part in FIG. 3D;

FIG. 4A is a front view of a further casing of the battery in FIGS. 1A to 1C;

FIG. 4B is an enlarged view of a part in FIG. 4A;

FIG. 4C is a top plan view of the further casing in FIG. 4A;

FIGS. 4D and 4E are side views of the further casing in FIG. 4A;

FIG. 4F is a cross-sectional view of the further casing in FIG. 4A taken along its length;

FIG. 5A is a top plan view of a metal casing of the battery in FIGS. 1A to 1C;

FIG. 5B is a front view of the metal casing in FIG. 5A;

FIG. 5C is a top plan view of the metal casing in FIG. 5A unrolled;

FIGS. 6A, 6B and 6C show a second embodiment of a battery in accordance with the invention and usage thereof;

FIG. 7A is a front view of the battery in FIGS. 6A to 6C;

FIGS. 7B and 7C are side views of the battery in FIG. 7A;

FIG. 7D is a cross-sectional view of the battery in FIG. 7A taken along its length;

FIG. 8A is a front view of a body of the battery in FIGS. 6A to 6C;

FIGS. 8B and 8C are side views of the body in FIG. 8A;

FIG. 8D is a cross-sectional view of the battery in FIG. 8A taken along its length;

FIG. 8E is an enlarged view of a part in FIG. 8D;

FIG. 9A is a front view of a further casing of the battery in FIGS. 6A to 6C;

FIG. 9B is an enlarged view of a part in FIG. 9A;

FIG. 9C is a top plan view of the further casing in FIG. 9A;

FIGS. 9D and 9E are side views of the further casing in FIG. 9A;

FIG. 9F is a cross-sectional view of the further casing in FIG. 9A taken along its length;

FIG. 10A is a top plan view of a metal casing of the battery in FIGS. 6A to 6C;

FIG. 10B is a front view of the metal casing in FIG. 10A;

FIG. 10C is a top plan view of the metal casing in FIG. 10A unrolled;

FIGS. 11A, 11B and 11C show a second embodiment of a battery in accordance with the invention and usage thereof;

FIG. 12A is a front view of the battery in FIGS. 11A to 11C;

FIGS. 12B and 12C are side views of the battery in FIG. 12A;

FIG. 12D is a cross-sectional view of the battery in FIG. 12A taken along its length;

FIG. 13A is a front view of a body of the battery in FIGS. 11A to 11C;

FIGS. 13B and 13C are side views of the body in FIG. 13A;

FIG. 13D is a cross-sectional view of the battery in FIG. 13A taken along its length;

FIG. 13E is an enlarged view of a part in FIG. 13D;

FIG. 14A is a front view of a further casing of the battery in FIGS. 11A to 11C;

FIG. 14B is an enlarged view of a part in FIG. 14A;

FIG. 14C is a top plan view of the further casing in FIG. 14A;

FIGS. 14D and 14E are side views of the further casing in FIG. 14A;

FIG. 14F is a cross-sectional view of the further casing in FIG. 14A taken along its length;

FIG. 15A is a top plan view of a metal casing of the battery in FIGS. 11A to 11C;

FIG. 15B is a front view of the metal casing in FIG. 15A; and

FIG. 15C is a top plan view of the metal casing in FIG. 15A unrolled.

### DETAILED DESCRIPTION OF EMBODIMENTS

Referring to the drawings, there is shown a liquid-activated battery 100 embodying the invention for use as energy storage. The battery 100 remains inactivated until a preferred amount of liquid such as water or any other suitable water-based liquid is added to it. When the liquid is delivered into the battery 100 and reaches a liquid-activatable powder mixture 104 disposed in the battery 100, the powder mixture 104 and the battery 100 become activated to generate a potential difference between electrically-isolated positive and negative electrodes of the battery which may then be used as an electrical power source. The features and operation of this embodiment will be described in detail as follows.

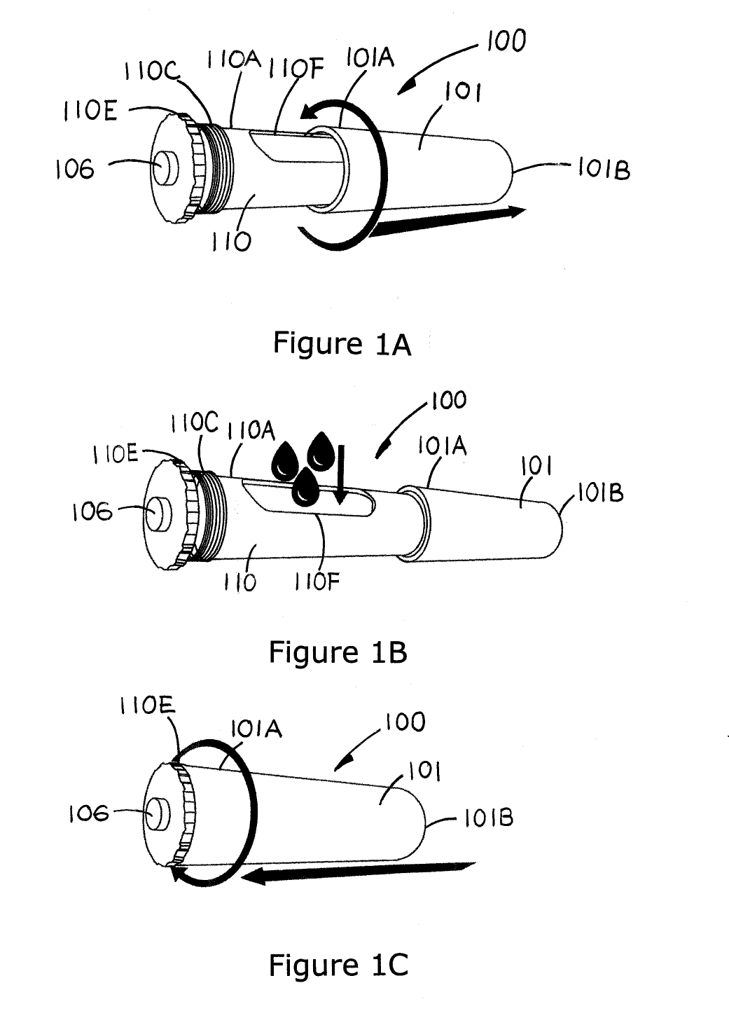

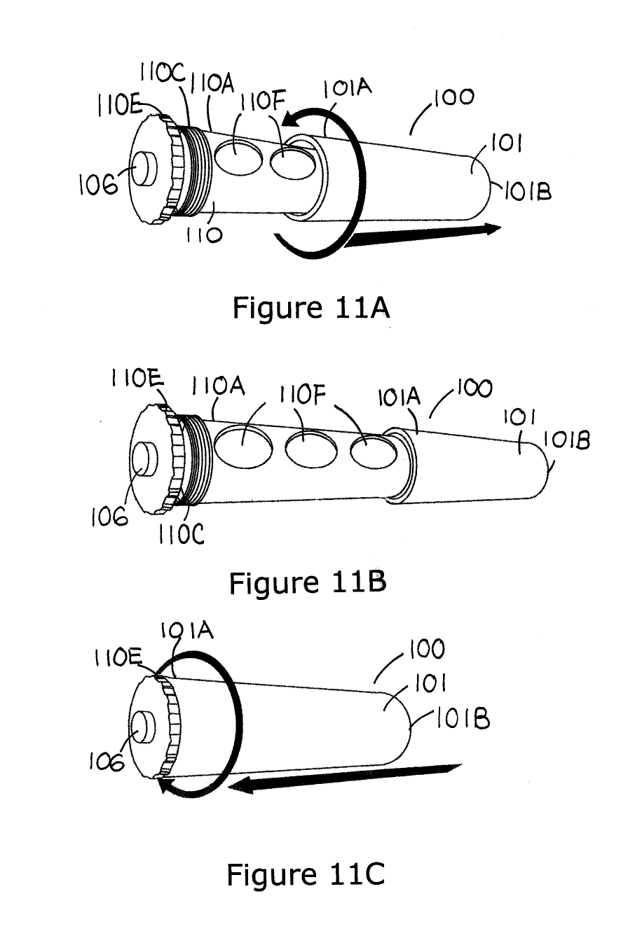

The battery 100 is generally cylindrical in shape and includes a body 101, preferably in the form of an outer plastic casing, containing a metal casing 102 with at least one perforation 102C, which is lined in its inner surface by a liquid permeable separator 103, preferably a paper membrane. A liquid-activatable reaction mixture 104, preferably a powder mixture or compacted lumps of powder, is physically and electrically isolated from the inner surface of the metal casing 102 by the liquid permeable separator 103. A core in the form of a carbon stick 105 extends inwardly of the metal casing 102 substantially horizontally and is embedded within/in contact with the reaction mixture 104. The metal casing 102 is arranged to move between a first position relative to the body 101 exposing the perforation 102C and a second position relative to the body 101 concealing the perforation 102C as shown in FIGS. 1A to 1C, 6A to 6C and 11A to 11C. Such movement may involve a relative sliding movement along an axis that runs longitudinally through the first and second ends of the body 101.

In a preferred embodiment, between the metal casing 102 and the body 101 there is provided a further casing 110 preferably made of plastic. This further casing 110 includes at least one opening 110F and preferably aligned with the perforation 102C on the metal casing 102. A passage of liquid can then be established for insertion of liquid when the opening 110F and the perforation 102C are exposed. In the preferred embodiment, the metal casing 102 is coupled to the further casing 110 in order for it to be movable by or with the further casing 110. The metal casing 102 may be attached to the further casing 110 by conventional means. To expose the opening 110F and the perforation 102C, the further casing 110 and the metal casing 102 are moved relative to the body 101 to the first position. To conceal the opening 110F and the perforation 102C, the further casing 110 and the metal casing 102 are moved relative to the body 101 to the second position.

Movement of the metal casing 102 and the further casing 110 to the first position requires sliding in a direction opposite but parallel to that required for moving the metal casing 102 and the further casing 110 to the second position. Again, such movement may involve a relative sliding movement along an axis that runs longitudinally through the first and second ends of the body 101.

In the second position, a wall of the body 101 conceals the openings 110F and the perforation 102C from external environment.

A cathode (positive electrode to which cations migrate) of the battery 100 includes the carbon stick 105, also commonly known as the conductive rod, surrounded by manganese dioxide and a first metal cap 106, preferably copper cap, provided at a first end 101a of the plastic casing 101 and fit onto a first end of the carbon stick 105A. The first copper cap 106 together with the first end of the carbon stick 105A extend outwardly of the first end 101A of the plastic casing 101 via an aperture in the first end 101A. An anode (negative electrode at which anions are oxidized) of the battery 100 includes the metal casing 102 and a second metal cap 107 electrically connected thereto. The second metal cap 107 and the second end 102B of the metal casing 102 are both provided adjacent the second end 101B of the plastic casing 101 and are electrically connected.

Once water contacts with the reaction mixture 104, the reaction mixture chemically reacts to generate a potential difference between the cathode and the anode. The cathode and anode are separated from each by the liquid permeable separator 103 which physically and electrically isolates the cathode and anode of the battery 100 but permitting free flow of positive ions created as a result of the chemical reactions from the anode towards the cathode so as to generate and maintain the potential difference. Electrons formed at the anode electrode are therefore able to flow from the anode through a load device back to the cathode.

When the potential difference across the battery 100 falls below a usable level, liquid can be re-filled into the battery 100 to reactivate the reaction mixture 104 and regenerate a usable potential difference across the cathode and anode.

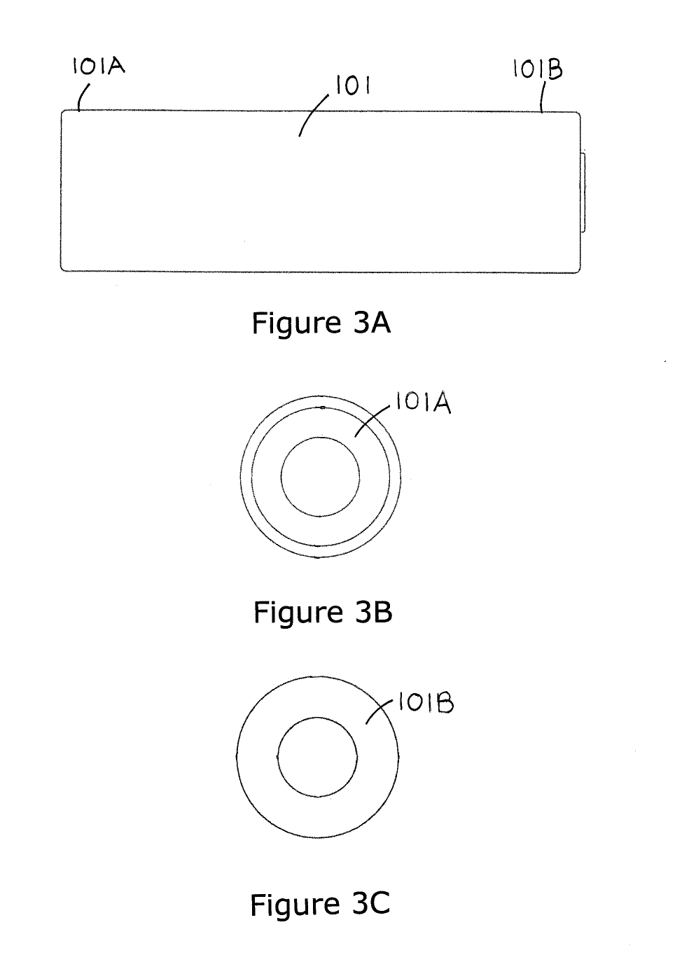

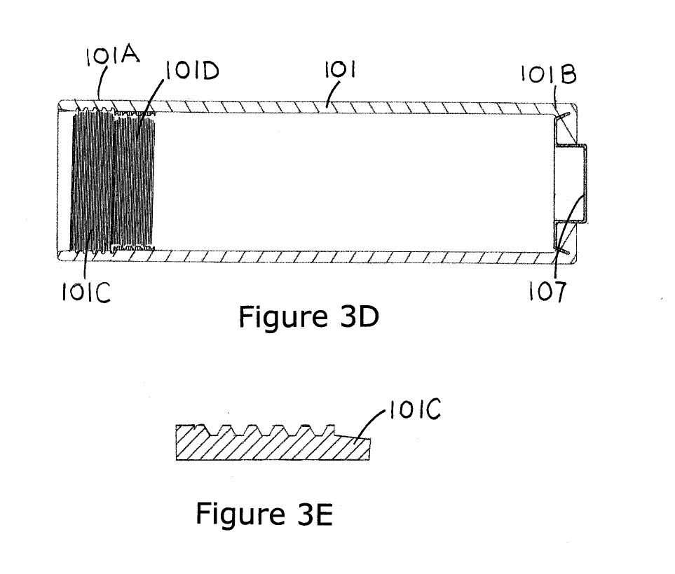

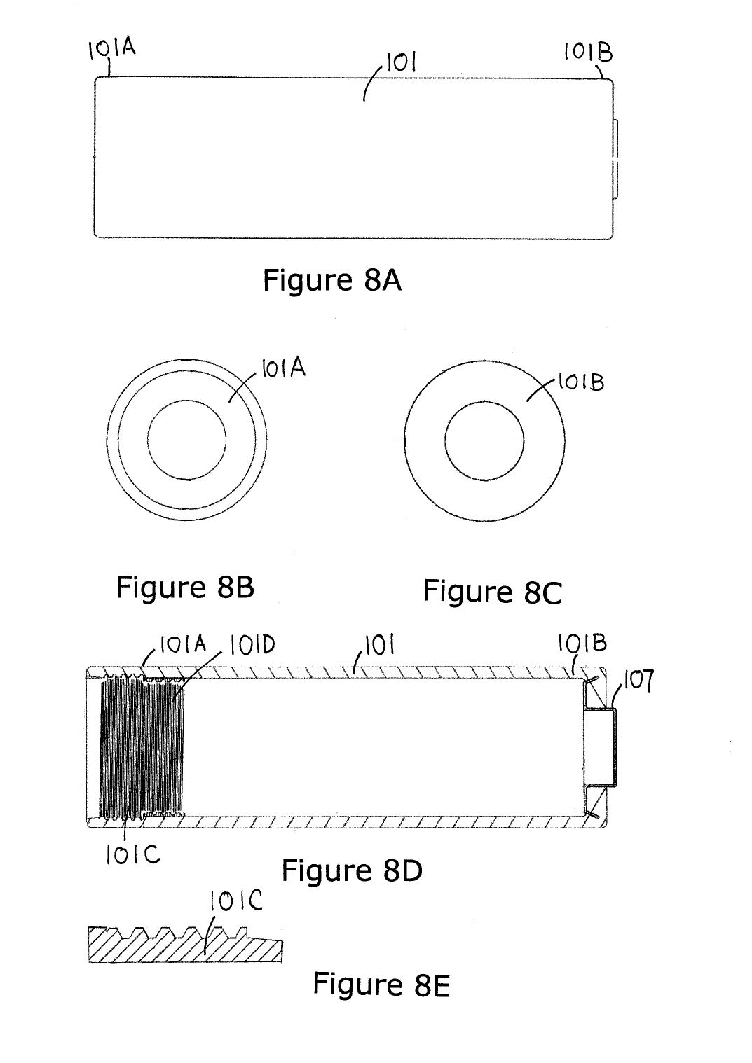

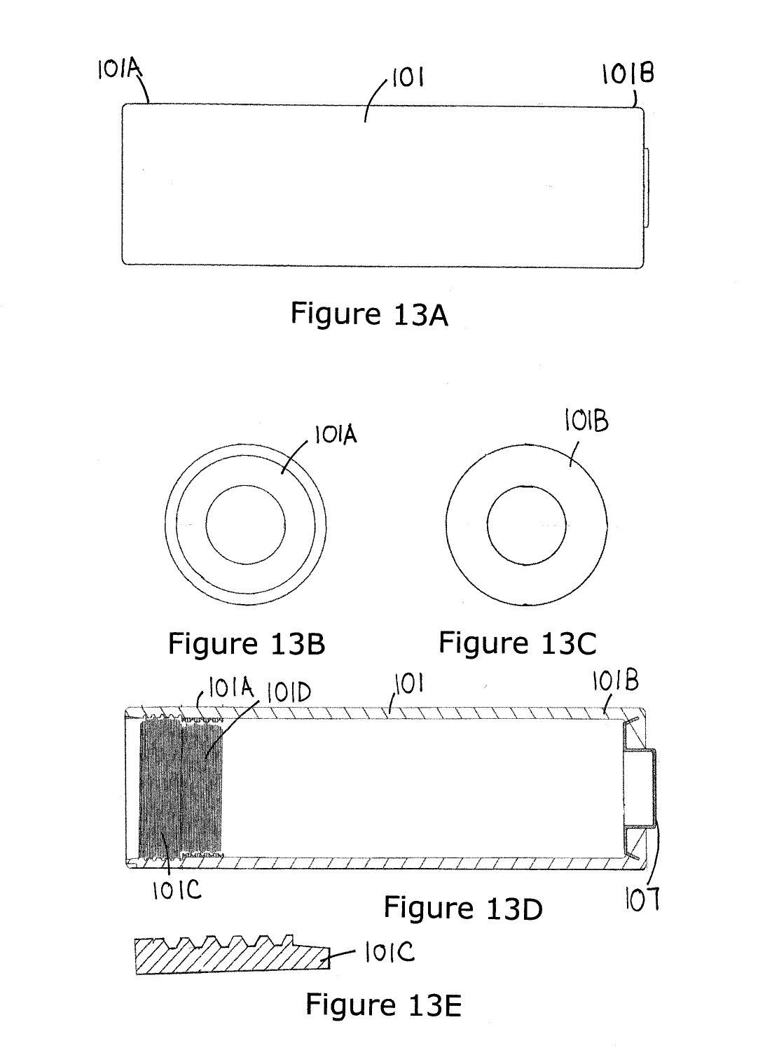

Referring to FIGS. 3A to 3E, 8A to 8E and 13A to 13E, the plastic casing 101 surrounds the further casing 110, metal casing 102 for reinforcement and protection against deformation due to stress or heat.

The plastic casing 101 is made of plastic material for example Acrylonitrile butadiene styrene (ABS) which is preformed, moulded and/or adapted to slide over the metal casing 102 or the further casing 110 as an outer sleeve. The plastic casing 101 is basically a cylindrical container with an opened end on its first end 101A. The first end 101A is provided with internal threaded engagement means 101C and threaded coupler 101D. At the second end 101B, there is a plastic bottom integrated with the second metal end cap 107. The threaded engagement means 101C and the threaded coupler 101D are concentric. The threaded coupler 101D forms a smaller radius compared to that of the threaded engagement means 101C and they are placed adjacent each other with the threaded coupler 101D placed further from the first end of the body 101.

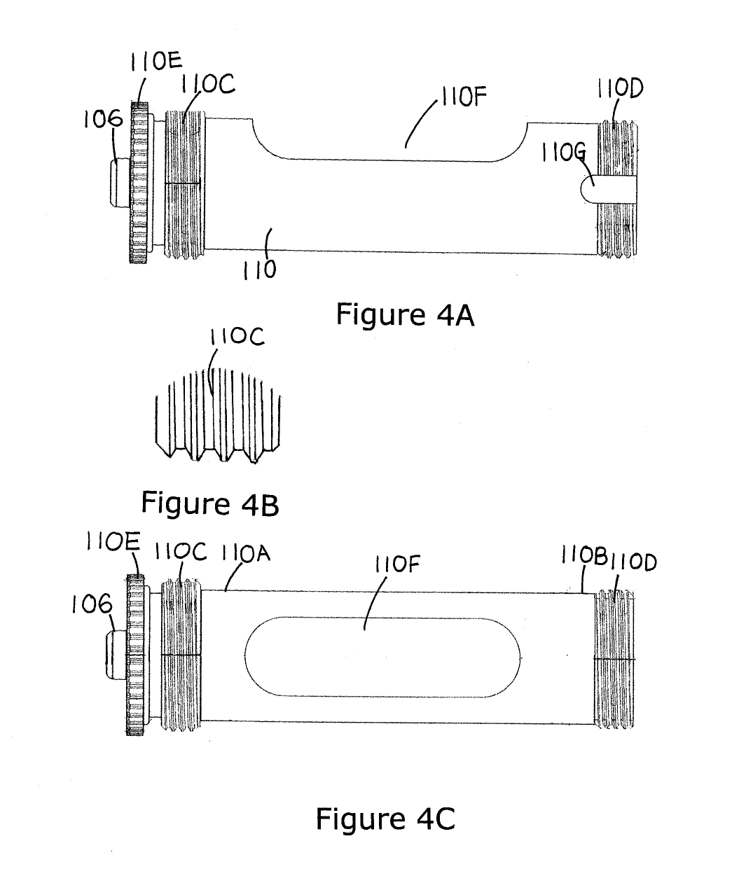

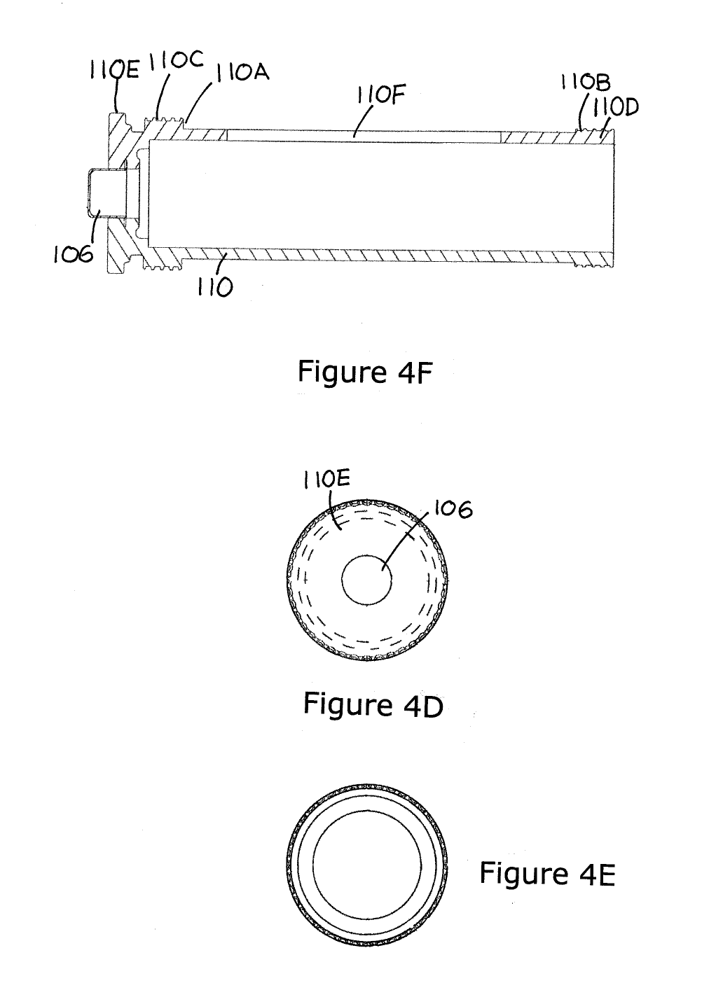

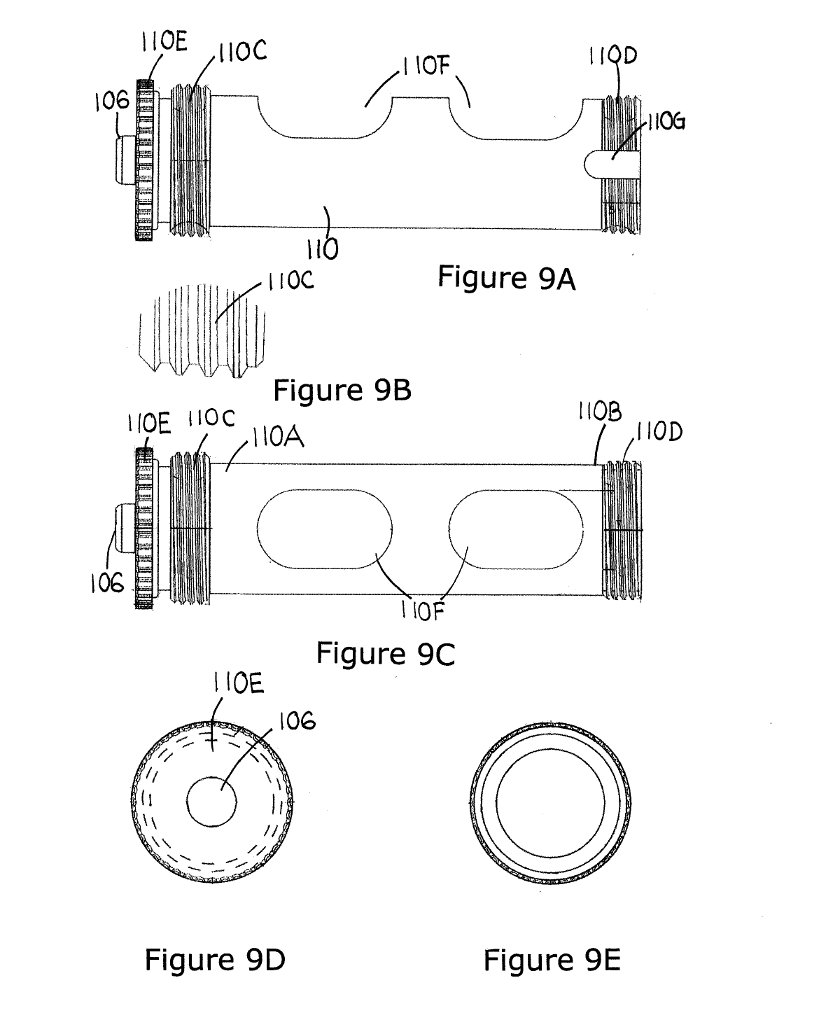

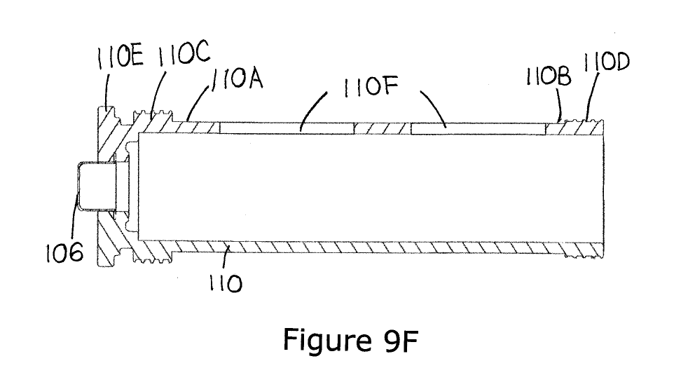

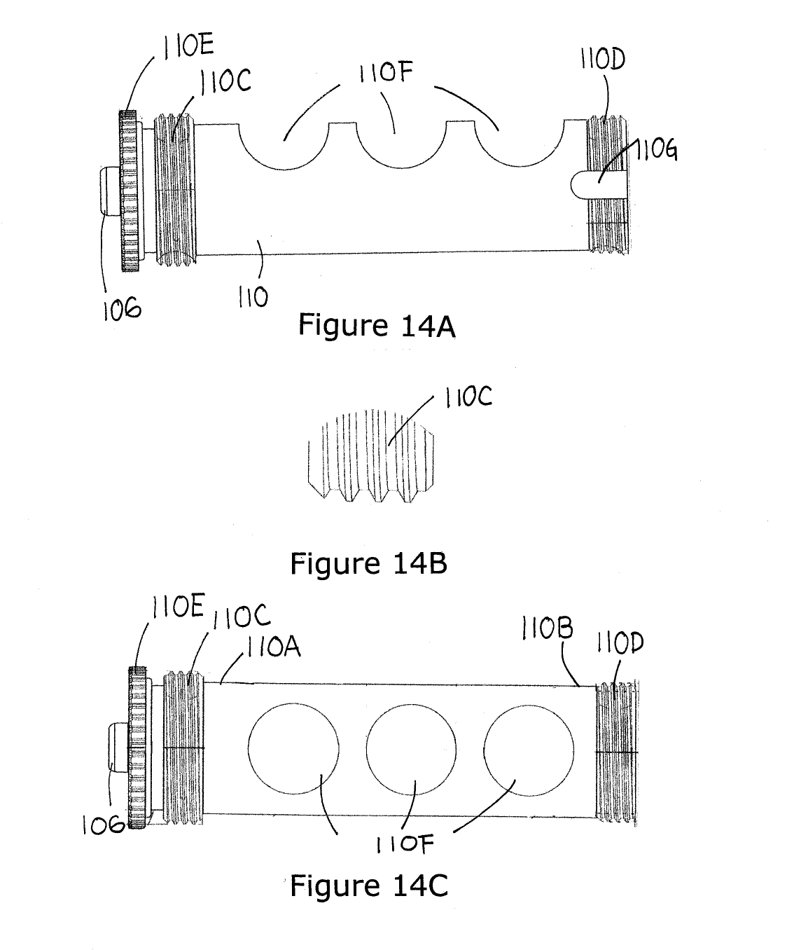

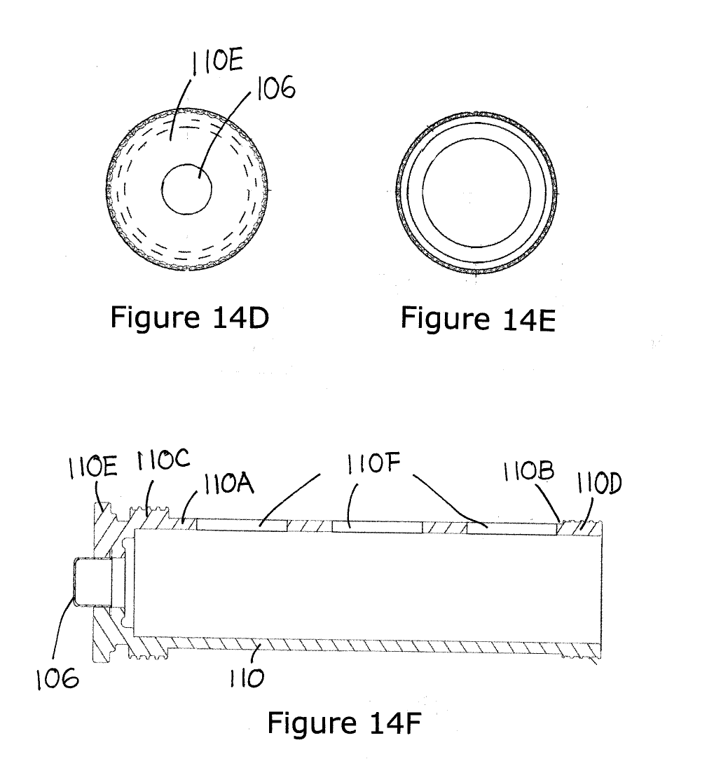

Referring to FIGS. 4A to 4E, 9A to 9E and 14A to 14E, there is shown the further casing 110 with first and second ends 110A and 110B. The further casing 110 is another cylindrical casing but with an end cap 110E integrally formed or fixedly connected with the rest of the casing 110. The first end cap 106 protrudes from the end cap 110E. The end cap 110E is spaced from an external threaded engagement means 110C on the periphery of the further casing 110 by a gap which is occupied by a seal ring such that when the threaded engagements means 110C and 101C are threadedly engaged to close off the opened end of the body 101, the engagement becomes a sealed engagement preventing at least liquid from entering or leaving the interior of the battery 100. The threaded engagement means 110C and 101C are releaseable complementary engagement means. The opening 110F is a through hole on the periphery of the further casing 110. In the first embodiment as shown in FIGS. 4A to 4E, there is only one opening of an oblong shape extending along length of the further casing 110. In the second embodiment as shown in FIGS. 9A to 9E, there are two oblong openings 110F extending along length of the further casing 110. These openings 110F are arranged consecutively and head to toe. In the third embodiment as shown in FIGS. 14A to 14E, there are three circular or oval shaped opening 110F extending along length of the further casing 110. These openings 110F are arranged consecutively and head to toe. In each of these embodiments, threaded couplers 110D are provided on the periphery and at the second end of the further casing 110. These threaded couplers 110D and the threaded engagement means 110C are concentrically arranged with the radius of the threaded couplers 110D smaller than that of the threaded engagement means 110C. The threaded coupler 110D abuts the threaded coupler 101D on the body 101 when the further casing 110 is moved to the first position exposing the openings 110F and the perforations 101A. These threaded couplers 110D and 101D are releasable complementary couplers. Preferably the further casing 110 is rotated relative to the body 101 such that the threaded couplers 110D and 101D threadedly engages to maintain the further casing 110 and the metal casing 102 at the second position by preventing relative sliding movement between the further casing 110 and the body 101 along the axis. If necessary, a stopper may be provided at an end of the threaded coupler 110D and/or 101D to prevent the removal of the further casing 110 and the metal casing 102 from the body 101 to satisfy the safety requirements such as those for toys for young children. Alternatively, the threaded coupler 110D and/or 101D may have no stopper to purposely allow complete separation between the further casing 110 and the metal casing 102 from the body 101. This allows the further casing 110 and the rest to be immersed into liquid for full activation. At the second end 110B of the further casing 110 and cutting through the threaded coupler 110D there is provided a pair of seats 110G preferably in the form of indentations.

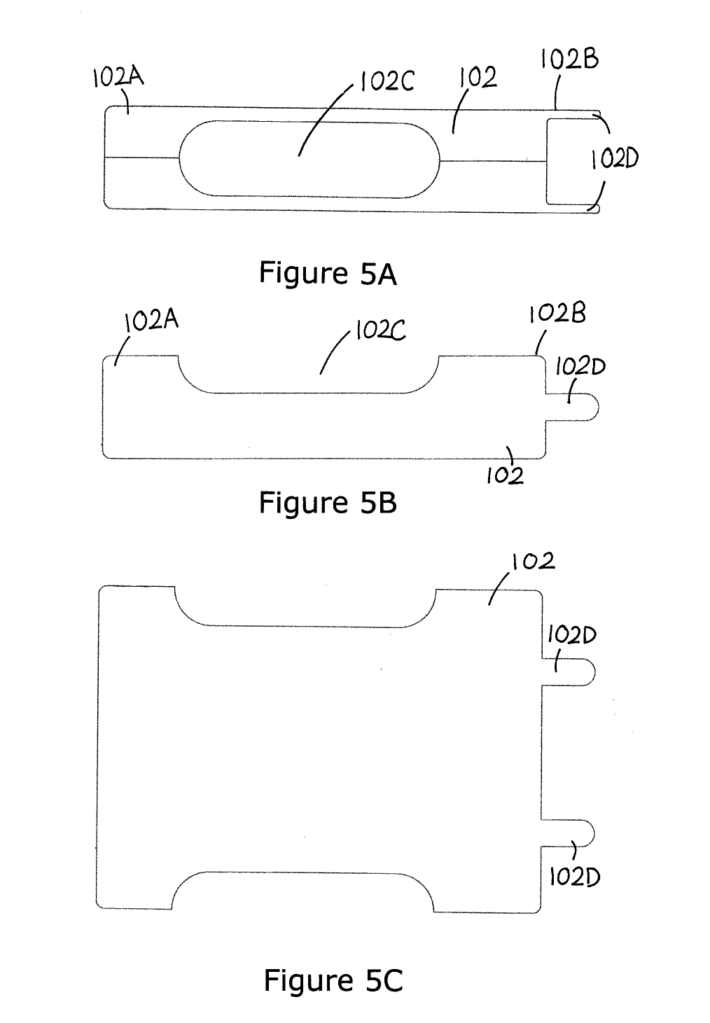

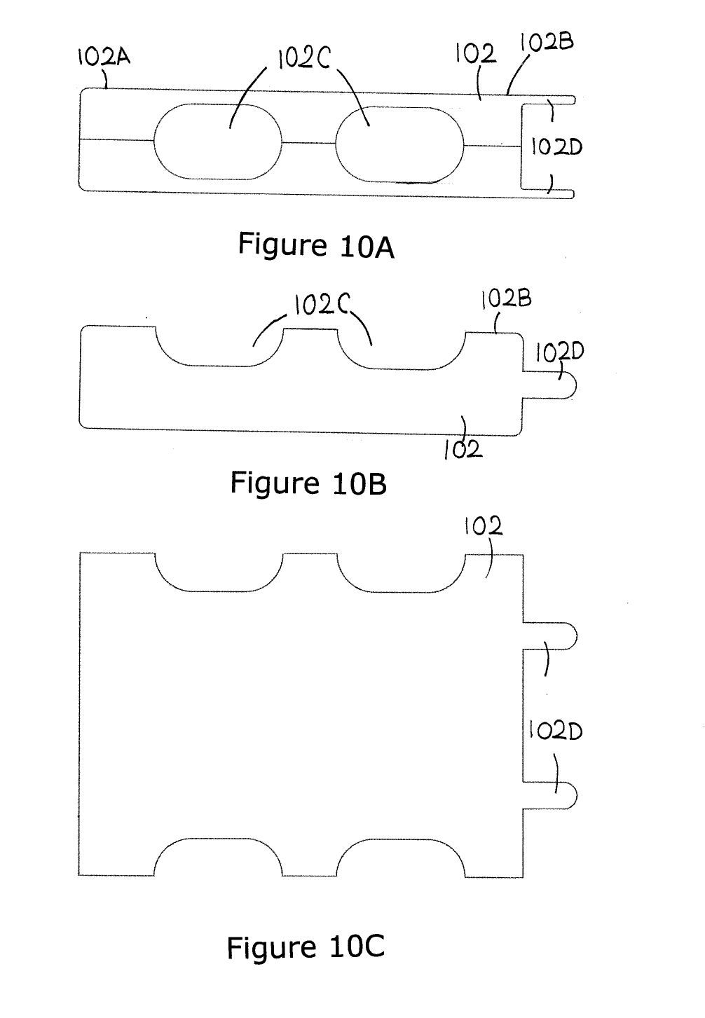

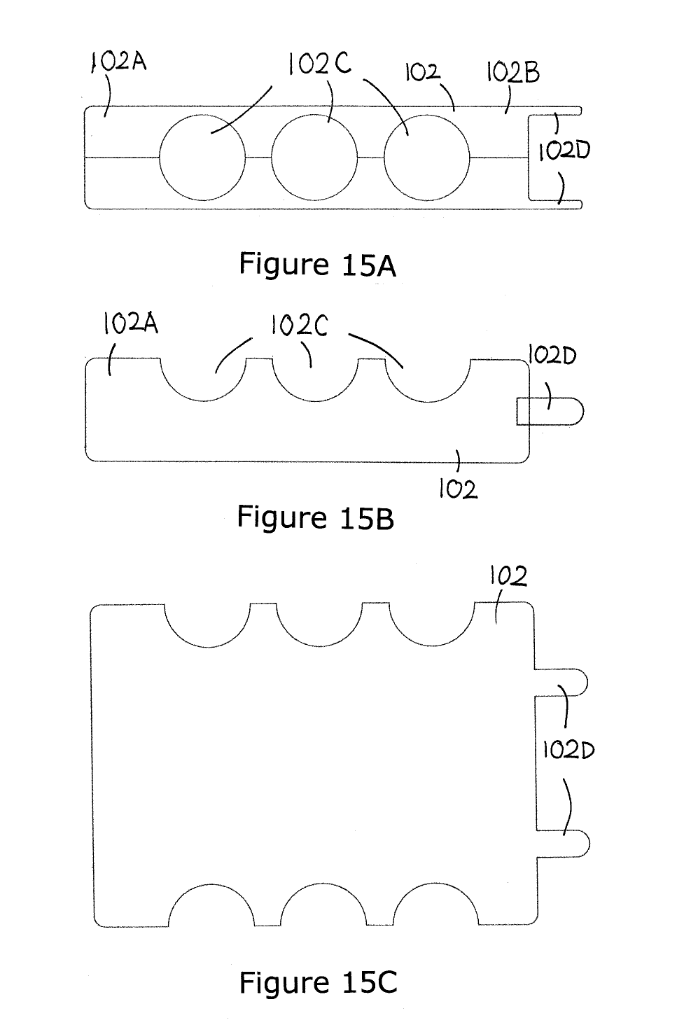

Turning to FIGS. 5A to 5C, there is shown the metal casing 102 with first and second ends 102A and 102B. perforation 102C is provided on the periphery of the metal casing 102 between the first and second ends 102A and 102B. A pair of projections 102D projects from the second end 102B of the metal casing 102. These projections 102D are foldable backwards with their free ends pointing at the first end 102A. These projections 102D are inserted into the seats 110G when the battery 100 is assembled. The projections 102D and the seats 110G are dimensioned and shaped to fit each other such that their cooperation prevents relative rotation between the metal casing 102 and the further casing 110. Adhesive may be applied here to secure them together. The perforation 102C is a through hole on the periphery of the metal casing 102. In the first embodiment as shown in FIGS. 5A to 5C, there is only one perforation 102C of an oblong shape extending along length of the metal casing 102. In the second embodiment as shown in FIGS. 10A to 10C, there are two oblong perforations 102C extending along length of the metal casing 102. These perforations 102C are arranged consecutively and head to toe. In the third embodiment as shown in FIGS. 15A to 15C, there are three circular or oval shaped perforations 102C extending along length of the metal casing 102. These perforations 102C are arranged consecutively and head to toe. The perforations 102C, the shape of the metal casing and the projections are die cast out of a piece of zinc sheet metal in a single step.

In a preferred embodiment, the external periphery of the body 101 is relatively easy to decorate with commercial indicators and information relative to the battery 100.

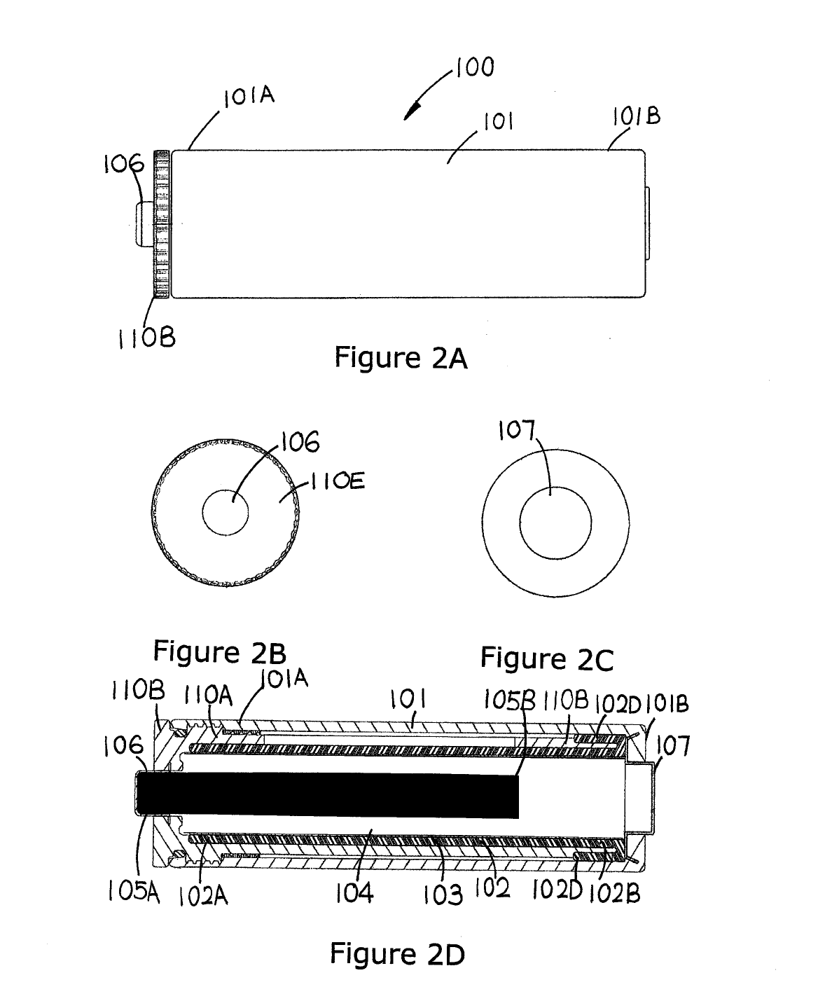

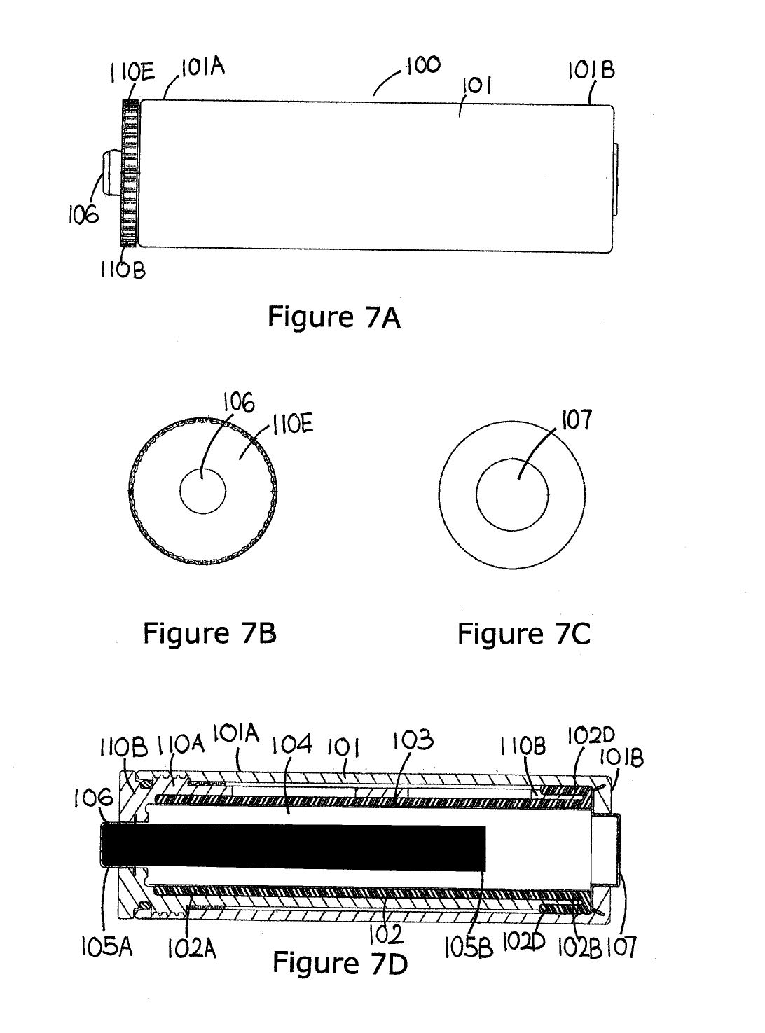

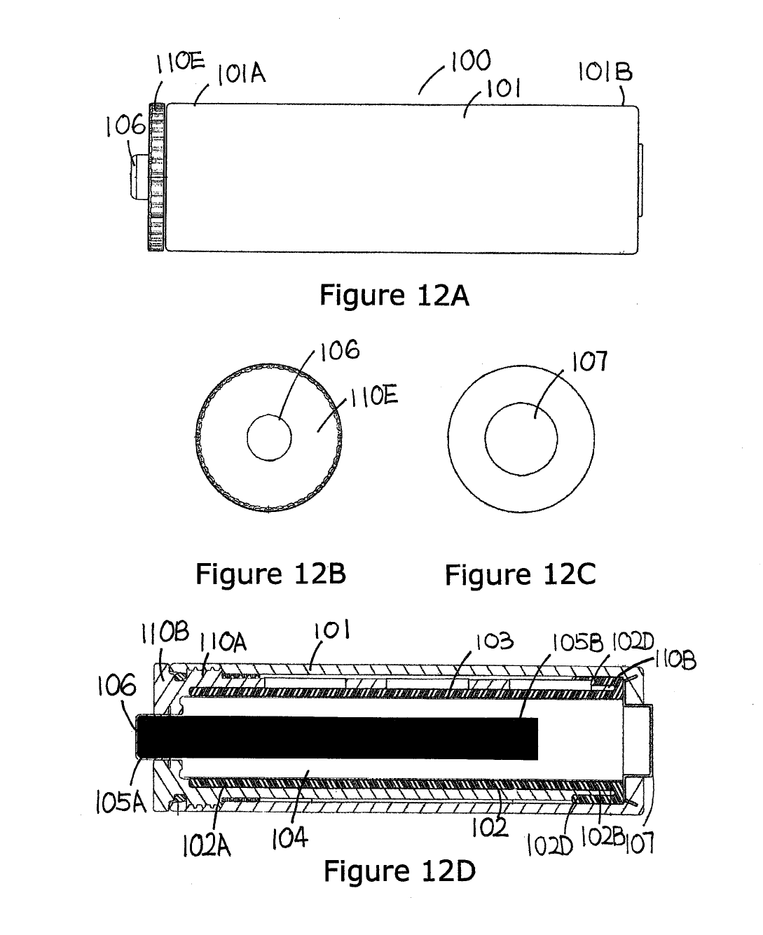

The perforations 102C or preferably the interior of the metal casing 102, as shown in FIGS. 2D, 7D and 12D, is lined by a liquid permeable separator 103 in the form of a paper membrane. Preferably, the liquid permeable separator 103 at each perforation 102C has an indicator to provide visual indication as to whether liquid passed there through. This may involve a change of color.

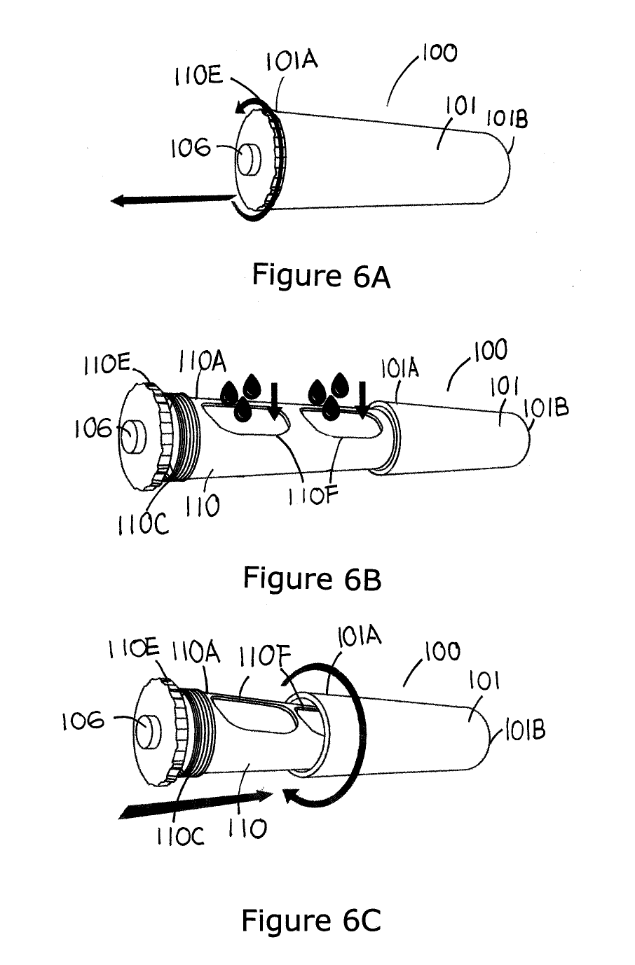

The passage of liquid through one perforation 102C of the embodiments as shown in FIGS. 6A to 15C may only activate the ingredients partially for one use. Further usage will require further activation through other perforation 102C.

The invention has been given by way of example only, and various other modifications of and/or alterations to the described embodiments may be made by persons skilled in the art without departing from the scope of the invention as specified in the appended claims.

1. A battery comprising:
a body having opposite first and second ends;
a liquid-activatable powder mixture disposed in the body;
a negative electrode, at which anions are oxidized, comprising a metal casing which has a first end that extends towards a second end longitudinally and includes at least one perforation;
a positive electrode, to which cations migrate, comprising a conductive rod which has a first end located adjacent and beyond the first end of the metal casing and that extends towards the second end of the body in contact with the powder mixture;
a permeable separator, disposed between the liquid-activatable powder mixture and the metal casing, for lining the perforation and electrically isolating the negative electrode from the positive electrode while being permeable to liquid useful in activating the powder mixture; and
a passage, extending from the perforation of the metal casing through the permeable separator, for allowing a flow of liquid to activate the liquid activatable powder mixture,
wherein the metal casing is moveable relative to at least the body between a first position to expose and a second position to conceal the perforation on the metal casing.

2. The battery as claimed in claim 1, wherein the first end of the body and the first end of the metal casing are sealed by a first end cap.

3. The battery as claimed in claim 2, wherein the body and the metal casing are separated by a further casing positioned therebetween and with first and second ends.

4. The battery as claimed in claim 3, wherein the further casing includes an opening which extends between the first and second ends and is aligned with the perforation on the metal casing, the further casing and the metal casing is moveable relative to the body between the first position to expose and the second position to conceal the opening on the further casing and the perforation on the metal casing.

5. The battery as claimed in claim 3, wherein the first end cap is provided with the first end of the further casing.

6. The battery as claimed in claim 5, wherein the first end cap of the further casing is integrally formed with the first end of the further casing.

7. The battery as claimed in claim 1, wherein the metal casing is movable between the first and second positions by sliding along an axis extending longitudinally through the first and second ends of the body.

8. The battery as claimed in claim 7, wherein the further casing and the metal casing are arranged to have their relative position fixed by an inter-engagement means such that the further casing and the metal casing are slidable between the first and second positions in unison.

9. The battery as claimed in claim 8, wherein the first end of the further casing is releasably coupled by a coupler to the first end of the body when the further casing is at the second position.

10. The battery as claimed in claim 9, wherein the coupler includes a pair of complementary threaded engagements on the respect first ends of the body and the further casing.

11. The battery as claimed in claim 10, wherein the coupler when engaged forms a waterproof coupling.

12. The battery as claimed in claim 11, wherein the coupler further includes a sealed ring positioned adjacent the threaded engagement on the further casing.

13. The battery as claimed in claim 1, wherein the second end of the metal casing is retained at least partially within the body by a retainer when the metal casing is moved to the second position.

14. The battery as claimed in claim 13, wherein the retainer comprises a releasable complementary threaded coupler at the second end of the metal casing and the first end of the body.

15. The battery as claimed in claim 8, wherein the second end of the further casing is retained at least partially within the body by a retainer when the further casing is moved to the second position.

16. The battery as claimed in claim 15, wherein the retainer comprises a releasable complementary threaded coupler at the second end of the further casing and the first end of the body.

17. The battery as claimed in claim 8, wherein the inter-engagement means includes a pair of projections on the second end of the metal casing insertable into a pair of seats on the second end of the further casing.

18. The battery as claimed in claim 17, wherein the pair of seats comprises a pair of indentations on the second end of the further casing.

19. The battery as claimed in claim 18, wherein the projection is of a shape corresponding to that of the indentation such that they form a close-fit.

20. The battery as claimed in claim 4, wherein the number of opening on the further casing correspond to the number of perforation on the metal casing.

21. The battery as claimed in claim 1, wherein the metal casing comprises at least two perforations, the permeable separator that lines the perforations comprises a visual indicator at each position of the perforations for indicating passing of liquid there through.

22. The battery as claimed in claim 14, wherein the threaded coupler when coupled maintains the metal casing at the second position.

23. The battery as claimed in claim 16, wherein the threaded coupler when coupled maintains the further casing at the second position.

24. The battery as claimed in claim 22, wherein the threaded coupler includes a stopper to prevent rotation of the metal casing relative to the body.

25. The battery as claimed in claim 23, wherein the threaded coupler includes a stopper to prevent rotation of the further casing relative to the body.
